(19) United States
(12) Patent Application Publication
(10) Pub. No.: US 2018/0218799 A1
(43) Pub. Date: Aug. 2, 2018

(54) DEVICE AND METHOD FOR PRODUCING NEUTRONS

(71) Applicant: NEUSCA SAS, Fontainebleau (FR)

(72) Inventor: Arash MOFAKHAMI, Buthiers (FR)

(21) Appl. No.: 15/748,011

(22) PCT Filed: Jul. 22, 2016
(86) PCT No.: PCT/EP2016/067510

§ 371 Date: Jan. 26, 2018

(30) Foreign Application Priority Data
Jul. 31, 2015 (FR) 1557374

(51) Int. Cl. G21G 7/00; H05H 3/06; H05H 6/00

(52) U.S. Cl. CPC G21G 7/00; H05H 6/005; H05H 3/06

(57) ABSTRACT

The invention relates to a method for producing and/or capturing neutrons, including the following steps: a) exposing nuclei selected among protons, deuterons and/or tritons to an electric field in order to extract said nuclei and to direct said nuclei thus extracted towards a target (20) containing free electrons; b) for example, exposing said nuclei to a spatial and/or temporal gradient of a first magnetic field so as to give a predefined orientation to the magnetic moments of the nuclei; c) either exposing the target to a second magnetic field so as to give a predefined orientation to the magnetic moments of the free electrons of the target; d) or using an electron-donor superparamagnetic material so that the electrons of the free layers of these materials are oriented in preferred directions generated by the orientation of the resulting magnetic moment of the superparamagnetic material; e) for example, in the case of using a superparamagnetic material, not exposing the proton beam and/or the target to the external magnetic fields. A heating device and/or a device for generating magnetic fields may be required in order to activate the superparamagnetic properties of the material.

The present invention relates in particular to the devices and methods for producing and/or capturing neutrons.

### BACKGROUND

It is known practice to produce neutrons by a nuclear fission reaction. This technology has the drawback of requiring a very significant framing given the risks that the nuclear fission reaction represents as well as high energy consumption.

Another technology used for the production of neutrons is spallation, that is to say the interaction of greatly accelerated (of the order of from an MeV to a GeV) energy photons, energy particles or light nuclei with heavy and/or neutron-rich nuclei. The impact of the incident energy beam (proton, electron or photons) on these nuclei frees the neutrons by fissioning the nuclei or by tearing away the excess neutrons in a directional cone. This technology, like the nuclear reaction, requires a heavy device and considerable investments to be able to achieve significant production levels, of the order of 10¹⁵ neutrons/cm².s for example. The radioactive danger is lower but the yields are also lower, with a high cost for the production of the targets which have a relatively short life (less than 2000 hours generally), and the significant energy consumed by the beam of incident particles, generally protons, which explains why this technology is very costly.

The international application WO 2009/052330 describes a method for generating neutrons comprising a step of collision of a beam of ions and of nuclei. The nuclei have the same spin state as the ions.

The international application WO 99/05683 describes an electrochemical method for electronic capture by protons in order to form neutrons.

The application EP 2 360 997 describes a method for generating neutrons, in which a beam of nuclei and a beam of electrons are made to collide. It is therefore necessary to produce, initially, beams of electrons and of nuclei. The device used can therefore be relatively complex, bulky and costly. Furthermore, the yield may be insufficient in as much as neutrons produced have to be used outside of the device, which can generate significant losses.

The patent application US 2014/0326711 relates to a method for producing heat, in which nickel and hydrogen are made to react in a sealed enclosure.

There is a need to reduce the economic and energy cost and simplify the production and the capture of neutrons.

### Method

According to a first of its aspects, the subject of the invention is thus a method for producing and/or capturing neutrons, comprising the following steps:

a) subjecting nuclei chosen from among protons (hydrogen nuclei), deuterons (deuterium nuclei) and/or tritons (tritium nuclei) to an electrical field in order to extract said nuclei and direct the duly extracted nuclei toward a target containing free electrons,

b) subjecting said nuclei to a spatial and/or temporal gradient of a first magnetic field so as to give a predefined orientation to the magnetic moments of the nuclei, in particular during their acceleration toward the target,

c) subjecting the target to a second magnetic field so as to give a predefined orientation to the magnetic moments of the free electrons of the target.

The magnetic moments of the electrons and of the nuclei can be aligned in the same direction. They can be parallel to the direction of displacement of the nuclei toward the target, being in the same direction or in the opposite direction. They can thus be collinear with the axis of the beam of nuclei extracted in the step b). To obtain such an alignment, the magnetic fields used can be axial, having their axis coincide with the axis of the beam of nuclei.

It is thus possible to provoke the generation of neutrons by collision. The neutrons thus produced can then be captured by the constituent nuclei of the target, which induces the transmutation of these same nuclei by neutron capture.

“Free electrons” should be understood to be the electrons of the conduction layers of the target, which are weakly linked to the atoms of the target and which can, thereby, participate in the circulation of the electricity. The layer which contains these free electrons can cover the target over a thickness from a few nanometers to a few micrometers at least on the side of the beam of nuclei.

“Magnetic moment” should be understood to mean the intrinsic magnetic moment of the particle, namely the nucleus or the electron. These particles are provided with charges and magnetic moments.

The electrons which have been oriented by the magnetic field(s), external magnetic field or magnetic fields generated by the superparamagnetic materials of the target itself, can originate from the constituent atoms of the target, that is to say for example from the atoms to be transmuted themselves, or else, in a variant, from specific atoms added for this purpose on the target or in the target, for example electron donors. These electron donors can also locally serve as magnetic field amplifier. In effect, some target materials, preferably heated beyond their Curie temperatures, can participate in boosting the gradient of the magnetic field locally under the combined effect of their own magnetism and of the external magnetic field imposed. Thus, the magnetic moments of the electrons can be at least locally aligned, under the effect of the gradients of the combined magnetic fields, with the magnetic moments of the incident nuclei, which then allows the generation of neutrons by electron capture.

The target can have superparamagnetic properties.

“Superparamagnetic properties” should be understood to mean that the target comprises one or more superparamagnetic materials. Superparamagnetism is a behavior of the ferromagnetic or ferrimagnetic materials which appears when they are in the form of small grains or nanoparticles. In grains of a sufficiently small size, the magnetization can be reversed spontaneously under the influence of temperature. The mean time between two reversals is called Neel relaxation time. In the absence of applied magnetic field, if the time used to measure the magnetization of these grains is much greater than the Nèel relaxation time, their magnetization appears nil: they are said to be in a superparamagnetic state. In this state, an external field can magnetize the grains, as in a paramagnetic material. Nevertheless, the magnetic susceptibility of the superparamagnetic grains is much greater than that of the paramagnetic materials.

In the case where the target has superparamagnetic properties, the target can be subjected to a sufficient temperature to trigger its properties of superparamagnetism. When the target having superparamagnetic properties, the heating of the target makes it possible to trigger its properties of superparamagnetic.

In the case where the target has superparamagnetic properties, it is also possible to subject the target to a second magnetic field so as to give a predefined orientation to the magnetic moments of the free electrons of the target. Such an exposure to a second magnetic field can make it possible to give a preferred direction to the orientation of the magnetized nanoparticles. This preferred direction can for example be the direction of the beam of incident protons or the reverse direction of the beam of protons.

The neutrons thus produced then come into interaction with the target, which can be metallic or non-metallic and covered by a metallic or conductive layer, preferably ferromagnetic, even superparamagnetic. In the case of a non-metallic target, the presence of the metallic or conductive layer provides the necessary electrons as well as an increase in the gradient of the local magnetic field if this layer is ferromagnetic, even superparamagnetic, to more effectively orient the magnetic moments of the linked electrons.

The electron capture by the incident nuclei is induced by the orientation of the magnetic moments of the interacting particles. This then makes it possible to generate cold, thermal, slow or rapid neutrons depending on the intensity of the potential applied to extract and accelerate the incident nuclei.

It is thus possible to obtain, in the method according to the invention, a production of neutrons in the target by induced electron capture of an electron by the incident nucleus, followed immediately by the capture of the neutrons produced by the nuclei of the target itself. This method can be used to produce energy, to produce isotopes, or to transmute nuclear waste.

One advantage of the invention is therefore that the production of neutrons can take place in-situ in the target, without a significant share of the neutrons being lost as is the case with the ex-situ neutron sources. Another advantage is the production of these neutrons with a low energy cost by virtue of the method for aligning the magnetic moments of the particles, in particular parallel to the axis of the beam of nuclei.

Moreover, the energy of the incident nuclei can be variable. It can be adjustable, particularly within the interval lying between 1 μeV and 25 MeV, better between 0.025 eV and 10 keV, even better between 0.01 eV and 0.4 eV.

The expression “give a predefined orientation to the magnetic moments”, also called “polarization”, means that the gradient of the magnetic field orients the intrinsic magnetic moments of the particles (nuclei and electrons, preferentially the electrons) in the direction of variation of the field and of the beam of nuclei. This orientation can affect at least 0.01%, even at least 1%, even at least 10%, even at least 50%, or even substantially all, of the particles entering into interaction under the magnetic field or fields.

The magnetic moments of the nuclei and of the electrons can be oriented in the direction of the gradient of the first magnetic field. The gradient of the first magnetic field can itself be oriented according to the axis of the beam of nuclei.

The energy of the neutrons produced can lie between 1 μeV and 25 MeV, preferably between 0.025 eV and 10 keV and even better between 0.01 eV and 0.4 eV. This energy can depend on the pulse communicated to the incident nuclei, and in particular on the electrical potential applied to extract the nuclei involved in the electron capture reaction.

According to another of its aspects, another subject of the invention is a method for producing and/or capturing neutrons, comprising the following steps:

a) subjecting nuclei chosen from among protons (hydrogen nuclei), deuterons (deuterium nuclei) and/or tritons (tritium nuclei) to an electrical field in order to extract said nuclei and direct the duly extracted nuclei toward a target containing free electrons,

b) subjecting said nuclei to a spatial and/or temporal gradient of a first magnetic field so as to give a predefined orientation to the magnetic moments of the nuclei, in particular during their acceleration toward the target,

c) subjecting the target to a sufficient temperature to trigger its properties of superparamagnetism, the target having superparamagnetic properties.

In the case where the target has superparamagnetic properties, the heating of the target makes it possible to trigger its superparamagnetic properties.

In the case where the target has superparamagnetic properties, it is also possible to subject the target to a second magnetic field so as to give a predefined orientation to the magnetic moments of the free electrons of the target. Such an exposure to a second magnetic field can make it possible to give a preferred direction to the orientation of the magnetized nanoparticles. This preferred direction can for example be the direction of the beam of incident protons or the reverse direction of the beam of protons.

### Incident Nuclei

The nuclei can be obtained by creating a plasma of hydrogen and/or of deuterium and/or of tritium, by application of radiofrequencies, which will be described hereinbelow, or of high voltage. The presence of an intensive magnetic field in the presence of radiofrequencies leads to a process of excitation of the plasma at electron cyclotronic resonance (ECR) of magnetron type, which can make it possible to substantially improve the containment and the maintenance of the plasma.

“Plasma” should be understood to be a set of anions and of electrons which are contained in a region of space. Preferably, a neutral gas of hydrogen, and/or of deuterium and/or of tritium is introduced into an enclosure maintained at a controlled pressure. This enclosure can be maintained at a powerfully low pressure, in particular vacuum pressure, by a vacuum pump. The pressure in the enclosure lies for example between 10⁻⁹ mbar and 100 mbar, better between 10⁻⁷ mbar and 10⁻³ mbar.

As a variant, the plasma can be obtained by means of an electrical discharge. The nuclei of hydrogen and/or of deuterium and/or of tritium can be obtained by high voltage application to the gas.

As another variant, the nuclei can be obtained by means of a source of nuclei or source of protons, which can for example be available on the market, for example under the trade names Monogan-M100, ECR ion source or Proton source.

In an exemplary embodiment, the hydrogen and/or deuterium and/or tritium gas is subjected to a radiofrequency field, which can lie between 10 MHz and 400 MHz, in particular under the influence of a magnetic field with or without gradient, so as to generate a plasma of this or these gases.

### Nature of the Sources of Nuclei

The method according to the invention can comprise, before the step a), a step of generation of the beam of nuclei.

As the source of nuclei that can be used in the context of the present invention, it is possible to cite the source taught in the publication “Ion Gun Injection In Support Of Fusion Ship II Research And Development” by MILEY et al., or “Modified extraction geometry in a radio-frequency ion source” by Kiss et al.

The sources of nuclei can comprise within them any type of accelerator of nuclei that can be used such as the rectilinear or linear accelerators, the circular accelerators like the cyclotrons or synchrotrons.

### Characteristics of the Beam of Nuclei

The beam of nuclei can have, at the moment of its generation, a diameter lying between 10⁻⁸ and 10⁻¹ m, for example between 10⁻⁶ and 10⁻¹ m, for example between 5·10⁻⁴ and 5·10⁻² m. “Diameter of a beam” should be understood to mean the greatest dimension of said beam in transverse section.

The beam of nuclei can have a flux lying between 10⁹ and 10²³ nuclei/s.

At least 50%, for example at least 75%, for example substantially all of the nuclei that make up the beam of nuclei, can have an energy lying between 1 μeV and 25 MeV, for example between 0.025 eV and 10 keV, for example between 0.01 eV and 100 eV.

The beam of nuclei can be emitted continuously. As a variant, the beam of nuclei can be pulsed. “Pulsed beam” should be understood to mean that the beam is emitted in the form of pulses of a duration for example less than or equal to one second, even to 1 ms, for example to 1 μs, for example to 1 ns, for example less than or equal to 10 ps, even less than 1 ps. The pulses have for example a duration lying between 1 ps and 1 ms. The time separating two successive pulses is for example less than or equal to 1 ms, for example to 1 μs, for example less than or equal to 1 ps.

The pulsed extraction can in particular make it possible to limit the disturbing interactions between the excess particles that have reformed from the atoms and/or from the molecules in the enclosure in a vacuum with the nuclei of the beam.

When the beam of nuclei is pulsed, the number of neutrons generated per pulse can for example lie between 1 and 10¹⁹ neutron/cm² per pulse, even between 10⁶ and 10¹⁷ neutron/cm² per pulse, better between 10¹² and 10¹⁵ neutron/cm² per pulse.

The production of neutrons can be performed in continuous form or in pulsed form.

In the case where the target contains ferromagnetic and/or superparamagnetic materials, it is possible to subject the target to a magnetic field so as to give a predefined orientation to the magnetic moments of the free electrons of the target.

### Radiofrequencies

Said nuclei can be subjected to radiofrequencies so as to give a predefined orientation to the magnetic moments of the nuclei. The application of these radiofrequencies can make it possible in particular to give an orientation to the magnetic moments of the badly oriented nuclei in the desired direction. These radiofrequencies can for example be of the order of 40 MHz.

The target can be subjected to radiofrequencies so as to give a predefined orientation to the magnetic moments of the free electrons of the target. The application of these radiofrequencies can in particular make it possible to give an orientation to the magnetic moments of the free electrons of the target that are badly oriented in the desired direction. These radiofrequencies can for example be of the order of 25 GHz.

The expression “subject to radiofrequencies” should be understood to mean “subject to a radiofrequency radiation”.

The frequency of the radiofrequencies is particularly dependent on the intensity of the magnetic fields involved as well as the type of beam (electron, proton, deuton or triton). The radiofrequencies can be applied using a radiofrequency generator, at a frequency lying between 10 kHz and 50 GHz, between 50 kHz and 50 GHz. The radiofrequencies produced can lie between 10 MHz and 25 GHz, even between 100 MHz and 2.5 GHz, being for example of the order of 45 MHz. The radiofrequencies can be applied by means of an antenna of a radiofrequency generator surrounding the enclosure or an antenna which is placed inside the enclosure for each beam of nuclei and/or of electrons. The orientation of emission of the radiofrequencies can be at right angles or parallel to the axis of the beam of nuclei.

The radiofrequencies used to produce the plasma can lie between 1 MHz and 10 GHz, even between 10 MHz and 1 GHz, better between 100 MHz and 700 MHz, being for example of the order of 200 MHz.

### Magnetic Fields

The first magnetic field applied can have an intensity lying between 0.005 Tesla and 25 Tesla, even an intensity lying between 0.1 Tesla and 1 Tesla, and a spatial gradient lying between 0.001 Tesla/meter and 1000 Tesla/meter, even between 0.01 Tesla/meter and 100 Tesla/meter, over the volume of an enclosure containing said nuclei, with for example a variation of the order of 10 Tesla/meter over the volume of the enclosure.

As a variant, the first magnetic field is variable in time, by the frequency and/or the form of the signal. The maximum intensity of the first magnetic field produced can lie between 0.005 Tesla and 25 Tesla. Within the enclosure, the gradient lies for example between 0.1 T/m and 1000 T/m.

In as much as the orientation of the magnetic moments of the particles depend on the gradient of the magnetic field over all of the target, to control this gradient over all the target, it is perhaps useful to have additional coils if necessary to correct the gradient which can be obtained by one or two coils placed on the same axis. Thus, the form of the gradient of the magnetic field will be able to be modified according to the size and the form of the targets.

The first magnetic field produced can be produced by means of one or more permanent magnets or one or more electromagnets. The first magnetic field can for example be generated by a variable current having a sinusoidal form or a peaked form. The electrical generator associated with the electromagnet can for example produce a continuous voltage and/or a variable voltage with frequencies lying between 1 Hz and 25 MHz. The application of this first magnetic field allows for the orientation of the magnetic moments of the nuclei.

The free electrons of the target can be subjected to a spatial and/or temporal gradient of the second magnetic field. Thus, the second magnetic field can have a spatial and/or temporal gradient. As a variant, this second magnetic field can be temporally and/or spatially constant. The second magnetic field can have a spatial gradient lying between 0.01 T/m and 1000 T/m in the volume of the target containing said electrons, being for example of the order of 10 T/m in the volume of the target. As a variant, the second magnetic field is variable in time, by the frequency and/or the form of the signal. The intensity of the second magnetic field produced can lie between 0.005 Tesla and 25 Tesla.

The second magnetic field produced can be produced by means of one or more permanent magnets or one or more electromagnets, or even by a radiofrequency generator, or even a combination thereof. The second magnetic field can for example be generated by a variable current having the sinusoidal form or a peaked form. The electrical generator associated with the electromagnet can for example produce a continuous voltage and/or a variable voltage with frequencies lying between 1 Hz and 25 MHz. The application of this second magnetic field allows for the orientation of the magnetic moments of the electrons.

The first and/or the second magnetic field can be produced by electromagnets with a power supply controlled by a signal generator. The signals can be square, sinusoidal or rectified signals, for example generated by thyristors, for example with a Graetz bridge. It is for example possible to use the voltages and currents outgoing from the Graetz bridge, with the delay angle of the thyristors equal to 20°, as illustrated on the web page https://fr.wikipedia.org/wiki/Thyristor. The currents of this type can generate temporal magnetic field variations.

The electromagnet(s) can be with or without ferromagnetic core, for example one electromagnet with core and another without core, which can make it possible to favor obtaining a spatial gradient of the magnetic field.

In another embodiment, the core of the electromagnet can be pierced to supply the plasma with gas. In another embodiment, the intake of gas can take place through the wall of the enclosure.

The first and/or the second magnetic field can be accompanied by a generation of frequencies, for example lying between 1 Hz and 25 MHz. The application or applications of radiofrequencies can provide an additional aid to the orientation of the magnetic moments of the electrons and of the nuclei and thus allow for an increase in the yield of the method of the invention. The radiofrequencies can lie between 1 MHz and 50 GHz, for example at 42 MHz for the nuclei and at 25 GHz for the electrons under a magnetic field of approximately 1 Tesla. The frequencies depend on the magnetic field applied.

According to another variant embodiment of the invention, a single coil can generate a magnetic field which replaces the two magnetic fields. This coil can be a coil with or without core.

### Electrical Field and Potential Difference

The electrical field applied, notably to the plasma, can be obtained by one or more electrode(s), in particular a pair of anode/ground or ground/cathode electrodes, in order to subject the nuclei to an electrical potential difference.

The pair of electrodes can be borne by an electrode holder. The electrode and the ground can be of identical form, to within the polarity thereof. The electrode holder can have the form of a ring, comprising two housings for the electrode and the ground, which can be of identical form.

Furthermore, the electrode holder can be pierced by radial orifices, two of them for example, and which can be diametrically opposite. These radial orifices can be used to fix the electrode holder in the device.

The electrode holder can also comprise transverse orifices. Transverse orifices can be used for the passage of electrical connections, on the sides of the enclosure, being furthest away from the central axis of the enclosure. These transverse orifices can also be of smaller diameter. There can be six of them, being placed symmetrically around the central axis of the enclosure.

Transverse orifices can also be used for the passage of spacers, which allow for the holding of the electrodes and of the support of the target. These spacers can be used for the circulation of one or more heat transfer fluid(s) and the extraction of the heat produced in the device. There can be four of them, like the spacers, and they can be placed symmetrically around the central axis of the enclosure.

Finally, other transverse orifices can be kept free, thus being able to be used to balance pressures in the device and for the circulation of the gases. There can be six of them, being able to be placed symmetrically around the central axis of the enclosure.

This pair of electrodes can be placed at a predefined distance from the plasma, preferably in immediate proximity thereto, and/or at a predefined distance from the target. The distance to the target can lie between 1 mm and 1 m, being for example of the order of 60 mm.

The anode electrode of the plasma can be brought to a potential lying between 0 V and 10 000 V, being for example of the order of 6 kV. The electrical field can lie between 100 V/m and 10 MV/m, being for example of the order of MV/m. Several pairs of electrodes can be used in order to increase the pulsing of the nuclei on the target.

As a variant, it is possible, for the plasma, to use a cathode and the ground. The cathode can then be brought to a potential lying between 0 V and −10 000 V, being for example of the order of −6 kV.

The anode or cathode voltage makes it possible to assign the nuclei the pulse desired according to the applications envisaged.

The electrical field applied, in particular on the target, can be obtained by one or more electrode(s), in particular a pair of ground/cathode, or anode/ground, electrodes, in order to subject the electrons of the target to an electrical potential difference.

At least one of the electrodes can be borne by an electrode holder, which can be as described above. The other electrode can be of generally tapered form.

This pair of electrodes can be placed at a predefined distance from the target, preferably in immediate proximity thereto.

In a variant embodiment, the target can itself be connected to the ground.

As a variant, the target can be connected to a cathode. The cathode can then be brought to a potential lying between 0 V and −10 000 V, better between −5 V and −500 V, being for example of the order of −300 V. In this case, the abovementioned electrode holder bears the ground.

The target or its enclosure can comprise at least one electrical connection on its surface.

### Target

The target can be metallic, even entirely of metal, which can in particular be the case when the method is used in order to produce energy.

As a variant, the target can be non-metallic, which can in particular be the case when the method is used for the purpose of transmutation for example. In this case, it can comprise a ferromagnetic or superparamagnetic metal jacket. It can for example comprise at least one of: Fe, Ni, Mo, Co, FeOFe₂O₃, MnBi, Ni, MnSb, MnOFe₂O₃, CrO2, MnAs, Gd, Dy, EuO, U, W, this list being nonlimiting. In this case, the target or its metal jacket can be linked to the cathode or to the ground, as explained above.

The target can be solid, liquid or gaseous. It can for example comprise at least nanoparticles, particularly in the case of the superparamagnetic materials, powder, foam, porous materials, composite materials, and/or materials in sol-gel form. It can also contain metallic and/or electrically conductive materials subjected to the magnetic field with or without gradient, this list being nonlimiting.

When the target is fluid, the fluid can be circulating or contained in a circulating solvent. The device can comprise means for circulating the fluid of the target. These means can for example comprise a pump, a mixer or a worm screw. The fluid and/or solvent can be chosen from the following list, which is nonlimiting: mercury, sodium Na, water. The possible solvent can for example make it possible to convey powder, for example powder of Ni or of Mo.

In a variant embodiment, in particular for the production of energy, the target can be a metal enclosure containing water.

The target can be heated to a temperature which can lie between 100° C. and 4000° C., even between 200° C. and 2000° C., better between 200° C. and 1700° C., even between 300° C. and 1500° C. It is for example possible to use an electrical resistor or another source of heat to heat the target. Such heating can make it possible to improve the orientation of the magnetic moments, particularly in the case where the target contains ferromagnetic and/or superparamagnetic materials, conduction electrons of the metal part of the target or of its metal jacket.

The heating of the target can allow the free electrons thereof to be less under the influence of the material medium and therefore more under the influence of the external fields. To increase the number of oriented electrons, it is preferable to increase the temperature of the target such that the “free” electrons of the Bloch layer interact less together and are subject more to the influence of the external field.

The method according to the invention can have a neutron production yield greater than 10⁻⁷. The “neutral production yield” is defined as: [number of transmutations/number of electrons extracted from the cathode linked to the target].

If the electron capture induced is performed by nuclei which themselves have neutrons, the quantity of neutrons freed can be greater than that of the neutrons created by the induced electron capture, simply through the freeing of the existing neutrons.

The number of neutrons produced can be greater than 10³ neutrons/cm².s for example, even greater than 10¹³ neutrons/cm².s, even better greater than 10¹⁹ neutrons/cm².s.

The method according to the invention can allow for the generation of a beam of neutrons. A “beam” should be understood to be a set of particles, driven at a rate, produced by a source in one or more given spatial direction(s). In this case, the target is replaced by a beam of electrons.

Another subject of the invention, independently of or in combination with the above, is a method for controlling the pulse of neutrons produced, in which the intensity of the electrical potential applied to extract the nuclei is controlled. In effect, the intensity of the extraction electrical field gives a greater or lesser pulse to the nuclei and therefore to the neutrons produced. In this way, it is possible to modulate the pulse of the neutrons produced to adapt it to the optimal effective neutron capture sections of the target materials.

The magnetic field gradient can be created locally by the combination of the magnetic field generation device and the magnetic behavior of the materials of the target to the nanometric, atomic and nuclear scale.

### Device

Also a subject of the invention, independent of or in combination with the above, is a device for implementing the method as defined above.

According to another of its aspects, another object of the invention is a device for producing and/or capturing neutrons, for example for implementing a method as described above, comprising:

a) an enclosure in which it is possible to place nuclei chosen from among protons (hydrogen nuclei), deuterons (deuterium nuclei) and/or tritons (tritium nuclei), for example by introducing therein a neutral hydrogen or deuterium and/or tritium gas under a controlled pressure, for example by a vacuum pump,

b) means for applying a spatial and/or temporal gradient of a first magnetic field so as to give a predefined orientation to the magnetic moments of the nuclei present in the enclosure,

c) means for applying an electrical field in order to extract said nuclei and direct the duly extracted nuclei toward electrons, these electrons being able to be free or belong to one the target,

d) means for applying a second magnetic field to said electrons so as to give a predefined orientation to the magnetic moments of the electrons.

The device can also comprise means for heating the target containing the electrons to activate the superparamagnetic properties of the target, in the case where the target has superparamagnetic properties.

The magnetic moments of the nuclei and the magnetic moments of the free electrons can be aligned in the same direction, in particular in the direction of displacement of the nuclei in the enclosure. These magnetic moments of the nuclei and of the free electrons can be parallel in the direction of displacement of the nuclei in the enclosure, being in the same direction or in the opposite direction. They can thus be collinear with the axis of the beam of nuclei extracted in the step c).

The magnetic moments of the electrons and of the nuclei can then be aligned in the same direction, which makes it possible to favor the capture of the electrons upon the collision thereof. The second magnetic field can have a spatial and/or temporal gradient. As a variant, this second magnetic field can be temporally and/or spatially constant.

The device can comprise means for generating nuclei from gas, for example by the generation of a plasma and by the extraction of the nuclei from this plasma using means for applying an electrical field, and therefore an electrical potential difference. The device can in particular comprise a radiofrequency generator surrounding the enclosure or incorporated in the enclosure, making it possible to create a plasm of hydrogen or of deuterium and/or of tritium in the enclosure, as explained above.

The means for applying the electrical field can comprise one or more electrode(s) and one or more ground(s), as explained above. These means for applying the electrical field can in particular comprise, in a first exemplary embodiment, an anode on the side of the enclosure from which the nuclei arrive and a connection to the ground on the opposite side, that is to say on the side of the target containing the electrons. In a second exemplary embodiment, these means for applying the electrical field can comprise a connection to the ground on the side of the enclosure from which the nuclei arrive and/or where the plasma is produced and a connection to a cathode on the opposite side, that is to say on the side of the target which contains the electrons.

The device can in particular comprise one or more pairs of anode/ground or ground/cathode electrodes, each electrode or pair of electrodes being borne by an electrode holder.

The electrode holder can have the form of a ring, comprising two housings for the electrode and the ground, which can be of identical form. The electrode holder can comprise transverse orifices, for at least one out of passage for electrical connections, passage for spacers, and/or to balance pressures in the device and for the circulation of the gases.

The device can also comprise an insulating electrode holder, as described above, bearing an extraction electrode, as well as a focusing electrode, which may not be borne by the abovementioned electrode holder. The focusing electrode can have a generally tapered form. It can be borne by another electrode holder. It can be pierced with orifices to balance pressures in the device and for the circulation of the gases.

Between the electron extraction electrodes and the nuclei acceleration electrodes and the target, the device can comprise radiofrequency antennas. The abovementioned electrodes can also serve as radiofrequency antenna.

### Beam

The device can comprise a source of electrons making it possible to produce a beam of electrons. It can be for example an electrode, for example a cathode, and a ground electrode allowing the extraction of the electrons from a target. The electrode can be the target itself. It can be brought to a temperature for example lying between 100° C. and 4000° C., better between 200° C. and 1700° C. In another variant, the cathode can be a field-effect cathode.

The application of the second magnetic field allows the orientation of the magnetic moments of the electrons. Thus, it is possible to allow, for example, at least 50%, for example at least 75%, for example substantially all of the particles forming said beam to have oriented magnetic moments.

The beam of nuclei and the beam of electrons are thus made to interact, the particles of the two beams having their magnetic moments aligned, in the space contained between the two electrode pairs under a magnetic field with or without spatial and/or temporal gradient of the magnetic field.

The extraction electrode or electrodes can be produced in the form of a metal grating, for example in one or more of the materials from the following list, which is nonlimiting: tungsten, titanium, tantalum, gold, platinum, nickel, iron. The electrode can have an outline of ceramic or plastic material, allowing the insulation of the connections from one another. In one embodiment, these plastic or ceramic outlines can be pierced to promote the circulation of the gases within the enclosure of the device to the vacuum pump.

### Target

The device can comprise a target containing conduction electrons, intended to receive the nuclei. The magnetic moments of the electrons and of the nuclei can then be aligned in the same direction as the direction of the velocity of the incident nuclei, which can make it possible to promote the capture of the duly oriented electrons by the nuclei of the beam upon their collision at the target, in particular on the surface of the metal part of the target, where the free electrons of the electronic sea of the metal, in other words the electrons of the conduction layer, are located.

The target can contain ferromagnetic and/or superparamagnetic materials. The target can be composed partly or wholly of ferromagnetic and/or superparamagnetic materials which, combined with the magnetic fields, can improve the orientation and the maintaining of the magnetic moments of the electrons and of the nuclei at the moment of their collision.

The elements to be transmuted of the target can be elements of the metal part itself or other elements contained immediately behind the metal part.

This metal part can be thin, for example having a thickness of the order of from 1 μm to a few meters (10 m for example), depending on the desired applications. The applications can be: production of radio elements, transmutation of actinides and radioactive materials, production of thermal energy by neutron capture.

The metal part of the target can also be linked to a ground or cathode electrode.

The device can also comprise means for heating the target containing the electrons, as explained above. The device can also comprise means for extracting the heat from the target, as explained above.

### Enclosure

The enclosure can have an internal volume which can lie between 1 mm³ and 100 m³, better between 1 cm³ and 1 m³, even between 10 cm³ and 1 dm³. The enclosure can be small or large, depending on the applications sought and the number of neutrons to be produced.

### Vacuum and Temperature

The enclosure can be brought to a pressure for example less than or equal to 1 Pa, for example less than 10⁻⁵ Pa (10⁻⁷ mbar). An enclosure with a low pressure makes it possible to limit the density of particles and can therefore make it possible to limit the sources of potential disturbance of the beams.

Such pressures can, for example, be obtained by the use of ion vacuum pumps or by any means that might suit the invention.

The method according to the invention can take place in an enclosure containing substantially no material other than the particles intended to enter into collision.

### Wall of the Enclosure

The thickness and the nature of the material forming the wall of the enclosure will be able to be chosen so as to contain the radiations and particles produced after the electron capture and/or collision step, as well as any beams intended to be brought into collision. At least one material for the enclosure can be chosen from the following list, which is nonlimiting: quartz, stainless steel, titanium, zircon.

### Output Diaphragm

The device according to the invention, particularly when it is intended to produce free neutrons, can comprise an output diaphragm. For example, in the case where the device according to the invention is linked to another enclosure under vacuum, the output diaphragm can be a disk produced in materials that interact little with the neutrons so as to allow the beam of neutrons to pass. The output diaphragm can be composed, for example, of one or more material(s) that are weak absorbers of neutrons. The output diaphragm can comprise, for example carbon, magnesium, lead, silica, zirconium or aluminum. The output diaphragm can be of any form, for example circular, oval, elliptical, polygonal.

### Cooling and/or Energy Harvesting

The device can comprise cooling means and/or energy harvesting means for the production of energy, more particularly of primary thermal energy, in particular by a heat exchanger. This primary thermal energy can then be transformed into mechanical or electrical energy depending on the needs and applications.

In the case of the cooling, the heat exchanger can comprise a closed circuit of one or more heat transfer fluid(s). It can comprise means for recovering these heat transfer fluids. The heat transfer fluid can for example be chosen from the following list, which is nonlimiting: air, water, oils, and any heat transfer fluid appropriate to the application envisaged.

In the energy harvesting case, it is possible to use a single circuit or, as a variant, several circuits.

In the case of the use of a single circuit, the fluid used for the energy harvesting can change state, for example, change from the liquid state to the gaseous state. In this case, it can change state under a pressure that is constant or chosen according to the technical generation mode, or even change state at ambient pressure by changing volume. It can therefore change pressure and volume according to the embodiment most appropriate, for example, rotating a turbine, a piston engine or even for example for being used as a propulsion means.

As a variant, it is possible to use several circuits in order, for example, to avoid having the radioactive contamination of a first circuit affect the immediate environment of the neutron reactor. It is thus possible to use a second circuit, even a third circuit. The last circuit operates as described above in the case of a single circuit, making it possible to harvest the thermal energy produced through successive heat exchangers between the different circuits.

It is possible to use or transform this energy in the form of thermal energy and/or in the form of mechanical energy through turbines, pistons, sterling engines or any other appropriate systems, or even by transforming it into electrical energy by the addition of known devices, such as alternators, to the abovementioned mechanical energy transformation systems.

The heat transfer fluids used in the harvesting and heat exchange circuits can be chosen from: water, oils, molten salts or any type of material that becomes fluid at high temperatures such as, for example, sodium, lead, salts. Each circuit can comprise a different fluid, as necessary.

### Magnetic Fields

The first and second magnetic fields can be oriented in the axis of the device or at right angles thereto. Preferably, the first and second magnetic fields are parallel to the axis of the beams of nuclei and/or of electrons.

“Magnetic field gradient” should be understood to mean a magnetic field intensity that is non-uniform in space or in time. The spatial or temporal variation can for example lie between 1 μT and 100 Teslas, better between 1 mT and 50 Teslas, even between 1 Tesla and 10 Teslas. The size of the space where the magnetic field is applied can lie between 1 nm³ and 100 m³, better between 1 μm³ and 1 m³, even between 1 mm³ and 1 dm³. The magnetic field can be variable in time, it can vary slowly or abruptly, over long or short time periods, for example over a period lying between 1 ps and 10 s, better between 1 ns and 1 s, even between 1 μs and 10 ms, even between 10 μs and 1 ms.

The means for applying the gradient of the first magnetic field can comprise a first electromagnet for producing the first magnetic field, as explained above. As a variant, or in addition, these means can comprise a radiofrequency generator.

The means for applying the second magnetic field to said electrons can comprise a second electromagnet for producing the second magnetic field, as explained above. As a variant, or in addition, these means can comprise a radiofrequency generator. The radiofrequencies can lie between 1 MHz and 1000 GHz, better between 5 MHz and 100 GHz. The application of this second magnetic field allows for the orientation of the magnetic moments of the electrons. In one embodiment, the radiofrequencies can be 25 GHz for a 1 Tesla second magnetic field.

The interactions between the nuclei and the linked or free electrons for generating the electron captures can take place within the field of the second electromagnet.

The means making it possible to generate one or more magnetic fields implemented in the method or the device according to the invention can be chosen from supraconductive coils, resistive coils or “hybrid” coils comprising a resistive coil and a supraconductive coil. It is also possible to use resonant circuits, for example of RLC type, comprising at least one resonance coil.

### Magnetic Fields Used to Give a Predefined Orientation to the Magnetic Moments

The method according to the invention can comprise at least one step of application of at least:

i. a first magnetic field, configured to place the magnetic moments of the nuclei in a defined state, having a component that is static in time of an intensity lying between 1 μT and 100 T and/or a non-nil gradient only on the axis of the collision, and

ii. a second magnetic field, configured to place the magnetic moments of the electrons in a defined state, having a component that is static in time of an intensity lying between 1 μT and 100 T and/or a non-nil gradient only on the axis of the collision.

The first and second magnetic fields can be identical or distinct. The first and second magnetic fields can be generated by the same source or by distinct sources.

At least one, for example each, of the first and second magnetic fields can be static.

As a variant, at least one, for example each, of the first and second magnetic fields can comprise a static component and a non-nil variable component.

Hereinbelow, for a given magnetic field\vec{B} (x,y,z,t), its static component \vec{B} stat (x,y,z) and its variable component \vec{B} (x,y,z,t) are defined as satisfying: \vec{B} (x,y,z,t)=\vec{B} stat (x,y,z)+\vec{B}ₜ(x,y,z,t) in which \vec{B} stat (x,y,z) is a time-independent quantity and \vec{B}ₜ(x,y,z,t) is a time-invariant quantity comprising no term. In other words, the frequency spectrum of \vec{B} (x,y,z,t) does not have a peak centered on the nil frequency.

### Static Components

The features concerning the static components described below are also valid for the static magnetic fields having a nil variable component. The static component of the first magnetic field can for example have an intensity lying between 1 μT and 100 Tesla. The static component of the second magnetic field can for example have an intensity lying between 1 μT and 100 Tesla. Static components suited to the invention can be generated by supraconductive coils, resistive coils or “hybrid” coils comprising a resistive coil and a supraconductive coil.

The first and second magnetic fields can have different variable components. The variable components of the first and/or second magnetic fields can for example be applied in the form of at least one beam of photons. The application of a variable component can make it possible, for the particles involved, to increase the proportion of magnetic moments oriented in the direction of the static component in order to increase the probability of generation of neutrons or of nuclei upon collision.

In effect, quantum theory states that the application of at least one variable component having, for example, a frequency spectrum comprising at least one peak centered on a frequency equal to the resonance frequency of the magnetic moments can for example make it possible to induce transitions between different energy levels. This resonance frequency corresponds to the precession frequency of the magnetic moments around the static component of the field applied, called Larmor precession. It then becomes possible for magnetic moments, for example oriented, before application of the variable component, in the reverse direction of the direction of application of the static component, to absorb at least a part of the energy of the variable component applied and to transition to an oriented state in which said magnetic moments are aligned in the same direction as the static component.

It is for example possible to apply the variable component at the same time as the static component.

The measurement of the quantity of neutrons produced, of photons deflected or of electrical potential created by the photons not having undergone collision can, for example, allow an operator to have indicators on the need to apply the variable component of the first and/or second magnetic field(s).

The field lines of the variable component can be collinear with the beams of particles. As a variant, they can be non-collinear with the field lines of the static component. They can, for example, form with them an angle greater than 10°, for example greater than 45°. In particular, the field lines of the variable component can form an angle lying between 85° and 95° with the field lines of the static component.

The variable component of the first magnetic field can be applied in a known manner. As a variant, the variable component of the first magnetic field can be applied in the form of pulses whose duration the person skilled in the art will be able to determine. As an indication, the duration of the pulses can for example lie between 0.01 μs and 1 s, for example between 1 μs and 20 ms.

The variable component of the second magnetic field can be applied in a continuous manner. As a variant, the variable component of the second magnetic field can be applied in the form of pulses whose duration the person skilled in the art will be able to determine. As an indication, the duration of the pulses can for example lie between 0.01 μs and 1 s, for example between 1 μs and 20 ms.

The variable component of the first magnetic field can have a frequency spectrum comprising at least one peak centered on a frequency for example lying between 1 Hz and 50 MHz, for example between 50 Hz and 50 kHz, for example between 100 Hz and 1 kHz.

Within the context of the method according to the invention, the variable component of the second magnetic field can have a frequency spectrum comprising at least one peak centered on a frequency for example lying between 1 Hz and 50 MHz, for example between 50 Hz and 50 kHz, for example between 100 Hz and 1 kHz.

The variable components of the first and second magnetic fields can be generated by resonant circuits, for example of RLC type, comprising at least one resonance coil.

### Gradients on the Collision Axis

As mentioned above, the first and/or second magnetic field(s) can have a non-nil gradient on the collision axis.

Quantum theory states that the application of a magnetic field having a non-nil gradient can make it possible to place the magnetic moments in a defined state and align them collinearly with the field. It is also important for the angle between the velocity of the particles, the collision axis and the magnetic moments to be small, for example less than 10°, even less than 5°, preferably close to 0°.

The direction of the gradient can form a substantially nil angle with the collision axis. In the latter case, it is possible for the first and/or second magnetic field(s) to each comprise, in addition, a static components and a non-nil variable component. Said static and variable components can be as described above. In both cases, it is possible to separate the particles according to the direction of their magnetic moment. It is then possible to obtain, from one and the same beam of particles, either a beam containing particles with magnetic moments oriented in the same direction and the opposite direction of the gradient applied or a plurality of beams each having within it particles with magnetic moments oriented in one and the same direction.

Moreover, the first and/or second magnetic field(s) can have, on the collision axis, a gradient of non-nil intensity and, for example, less than 1000 T/m. The first and/or second magnetic field(s) having a non-nil gradient on the collision axis can be applied continuously.

As a variant, the first and/or second magnetic field(s), having a non-nil gradient on the collision axis, can be applied in the form of pulses.

Magnetic field gradients suited to the invention can for example be produced by two air gaps similar to those implemented in the Stern and Gerlach trial or by a plurality of windings having different numbers of loops and/or different diameters and/or currents.

### Energy Production and Harvesting

The capture and/or collision step can generate a release of energy, for example in the form of heat. The heat produced in this step can for example be harvested by a heat exchanger, as explained above, in which one or more heat transfer fluid(s) circulate.

According to another of its aspects, the invention relates to a method for producing energy by means of one of the methods and/or devices as described above, in which the energy produced is harvested.

According to yet another of its aspects, the invention relates to the use of the neutrons generated by the methods and/or the devices as described above to produce energy. Being slow and of high yield, the neutrons produced can make it possible to produce energy by neutron capture. In effect, it is established that the transmutation of the atomic nuclei by neutron capture generates energy. This source of energy can achieve an exceptional economical efficiency and progressively replace the other sources of energy. The efficiency of such systems can be greater than 200%, even than 1000% (a production of 10 times the energy consumed), even more.

A few examples of neutron capture are given below, with the energies obtained, according to the web site

http://www.nndc.bnl.gov/capgam/byn/page001.html.:

n+p→D+2223.25±0.00 keV

2n+⁵⁸Ni→⁶⁰Ni+8998.63±0.07 keV+1332.54±0.05 keV

n+⁶⁰Ni→⁶¹Ni+7819.56±0.06 kev

n+⁶¹Ni→⁶²Ni+1172.80±0.10 kev

### Uses

The neutrons can be useful in many applications, particularly in the fields of imaging, of radio-isotope production for the medical industry and nuclear energy for which the neutrons are a source of energy production, of nuclear reaction optimization, of safety of operation of the power plants and of the treatment of the radioactive waste like the minor actinides.

According to one of its aspects, the invention relates to a medical installation, for example for destroying human or animal cancerous cells, comprising at least:
a means for positioning a patient to be treated, and
a device as defined above.

The neutrons generated according to the invention can thus for example be used for hadron therapy or for example for nuclear medicine.

According to yet another of its aspects, the invention makes it possible to produce radio-isotopes. In the medical field, there are two major uses of radio-isotopes: imaging by injection of radio-pharmaceuticals (tracers) making it possible to create accurate images on the physiological metabolism, or to carry out certain medical acts and for sterilization of the medical equipment by gamma radiation. The neutrons produced can make it possible to generate gamma rays used in the sterilization of surgical instruments for example.

According to yet another of its aspects, the invention relates to the use of the neutrons generated by the methods and/or the devices as described above for nuclear transmutation or, more generally, to obtain nuclei in experimental physics, for the production of radio-isotopes by neutron capture.

According to yet another of its aspects, the invention relates to the use of the neutrons generated by the methods and/or the devices as described above for the treatment of nuclear waste by transmutation. The neutrons produced, which can be rapid, can be sent to the waste from the nuclear reactions in order to obtain radioactive elements that are lighter and with a shorter life and therefore less dangerous.

According to yet another of its aspects, the invention relates to the use of the neutrons generated by the methods and/or the devices as described above for imaging and neutron analysis. The device making it possible to produce a beam of neutrons is used more particularly in this case. The neutrons produced can make it possible to photograph, through the elements, the structure of any object. This method allows for a fine analysis of industrial parts. Likewise, the neutrons produced can allow analyses of soils and geological probes, for example certain exploratory drill holes. Finally, the neutron analysis is used for military and defense purposes, since, in the same conditions as for the other uses, a source of neutrons makes it possible to detect explosives, whatever the nature thereof.

According to yet another of its aspects, the invention relates to the use of the neutrons generated by the methods and/or the devices as described above for the creation of defects in physico-chemical systems. The device making it possible to produce a beam of neutrons is used more particularly in this case. The neutrons produced can make it possible to test the radiation resistance of the embedded apparatuses and instruments subject to nuclear stress.

According to yet another of its aspects, the invention relates to the use of the neutrons generated by the methods and/or the devices as described above in a nuclear power plant. The neutrons produced can allow for the inexpensive design of sub-critical operation nuclear fission power plants, which makes it possible to eliminate the risk of nuclear runaways and the need for uranium enrichment. The nuclear risk can thus be considerably reduced with a lower energy production cost. This also makes it possible to limit fossil energy consumption.

### DESCRIPTION OF THE FIGURES

The invention will be better understood on reading the following detailed description, of nonlimiting examples implemented thereof, and on studying the attached drawing, in which:

FIG. 1 is a schematic and partial perspective view of an example of a neutron production and/or capture device according to the invention,

FIG. 2 is a view according to the arrow II,

FIG. 3 is a view in longitudinal cross section according to III-III of the device of FIGS. 1 and 2,

FIG. 4 is a schematic and partial perspective view of a detail of the device of FIGS. 1 to 3,

FIG. 5 is a view according to the arrow V,

FIG. 6 is a view in longitudinal cross section according to VI-VI of the device of FIGS. 4 and 5,

FIG. 7 is a schematic and partial perspective view of an electrode holder assembly and its electrodes,

FIG. 7a is a schematic and partial perspective view of the assembly of FIG. 7,

FIG. 7b is a schematic and partial perspective view of the electrode holder of FIGS. 7 and 7a,

FIGS. 7c to 7e are views respectively according to the arrows C, D and E of the electrode holder of FIGS. 7, 7a and 7b,

FIG. 8 is a schematic and partial perspective view of the target surrounded by the associated electrode,

FIGS. 8a and 8b are views respectively according to the arrows A and B of the cathode of FIG. 8, and

FIGS. 9 and 10 are views similar to FIG. 3 of variant embodiments.

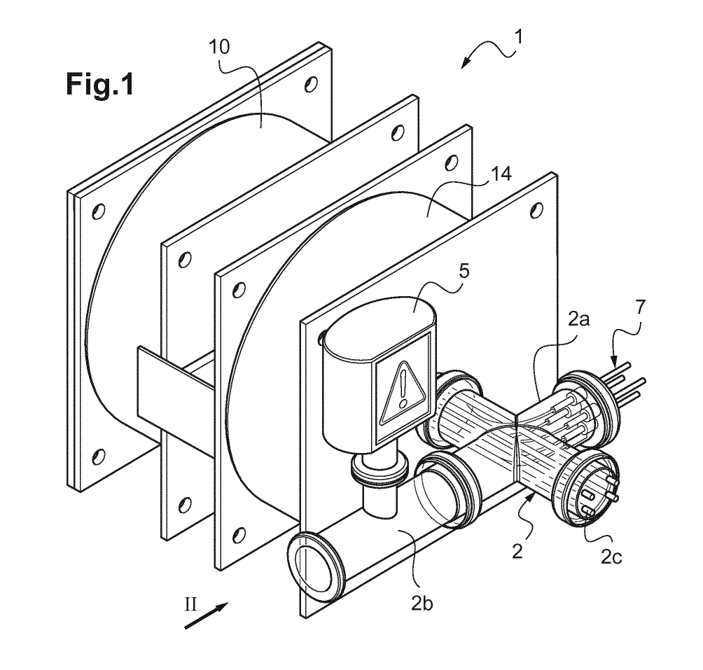

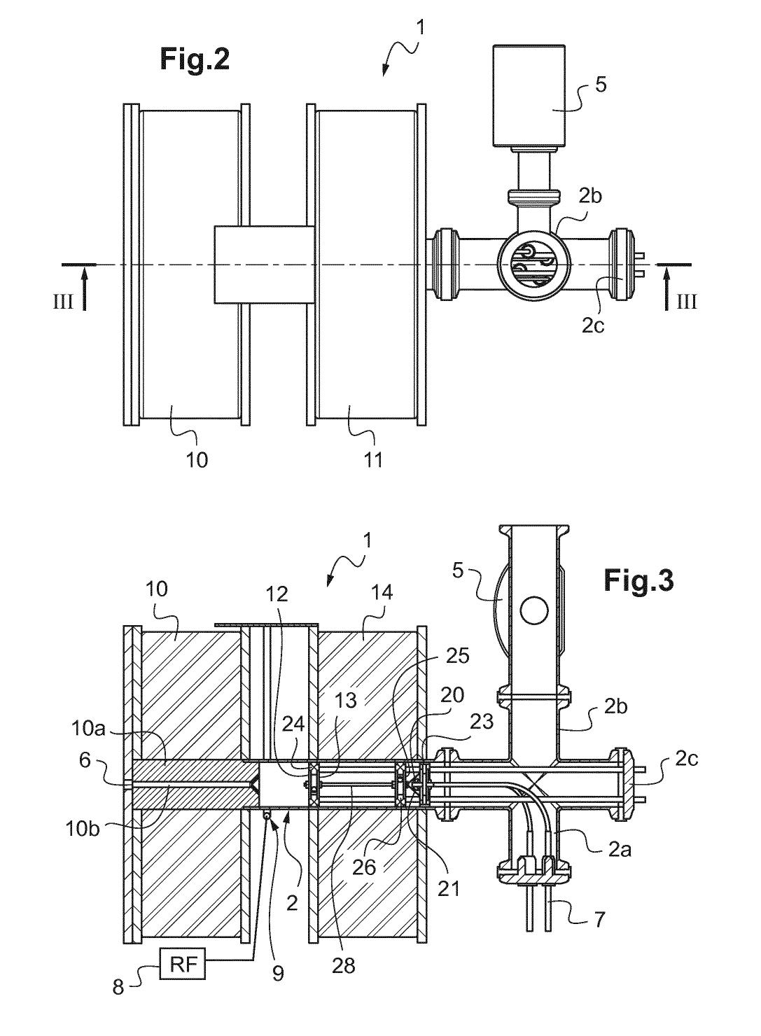

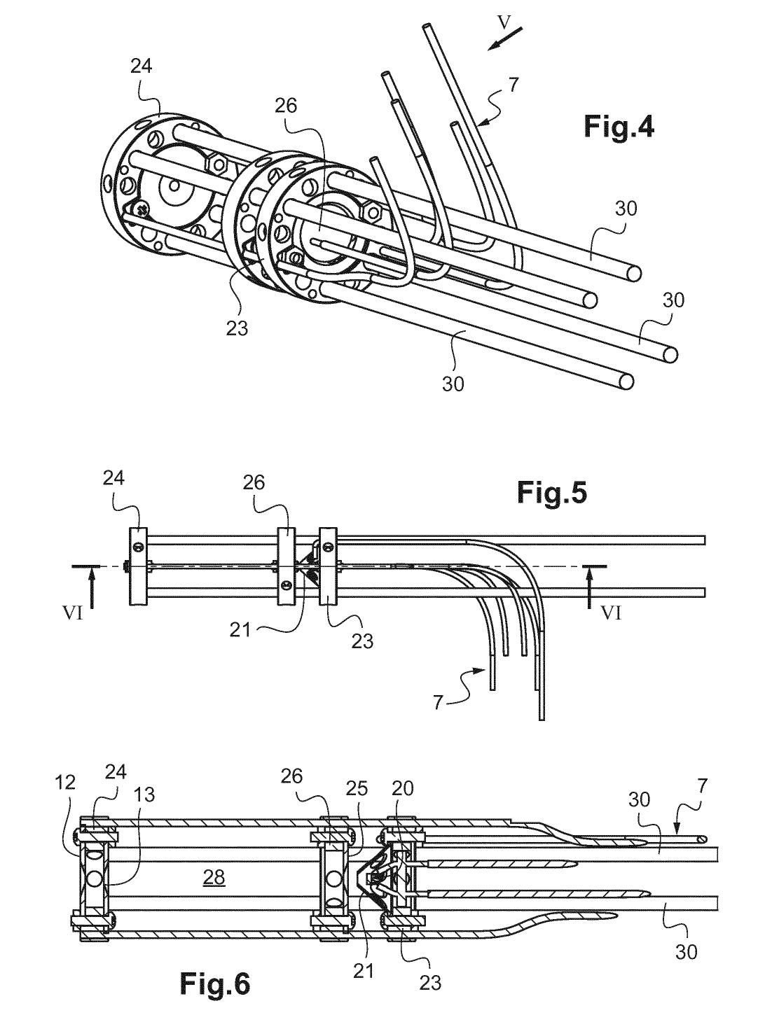

FIGS. 1 to 3 schematically illustrate a device 1 according to the invention, comprising an enclosure 2 in which nuclei can be placed at a pressure controlled by a vacuum gauge 5. The enclosure 2 has a generally cylindrical form, and comprises, toward its output end 2c, two lateral branches 2a and 2b, one 2a allowing the passage of the electrical connections 7, and the other 2b the discharging of the gases to the vacuum pump which is not represented. The output end 2c can serve as output for the neutrons produced and/or is input and output for a heat transfer fluid used to cool and/or harvest energy in the heat exchanger or exchangers.

The nuclei can be chosen from protons (hydrogen nuclei), deuterons (deuterium nuclei) and/or tritons (tritium nuclei) and are obtained for example by introducing into the enclosure a neutral hydrogen or deuterium and/or tritium gas through a gas input 6. The gas can be transformed into plasma by means of a radiofrequency generator 8 comprising an antenna 9 surrounding the enclosure 2.

The device 1 further comprises means for applying a spatial and/or temporal gradient of a first magnetic field, so as to give a predefined orientation to the magnetic moments of the nuclei present in the enclosure 2. This is, in the example described, an electromagnet 10 with core 10a. The core 10a comprises a channel 10b allowing the input of the gas.

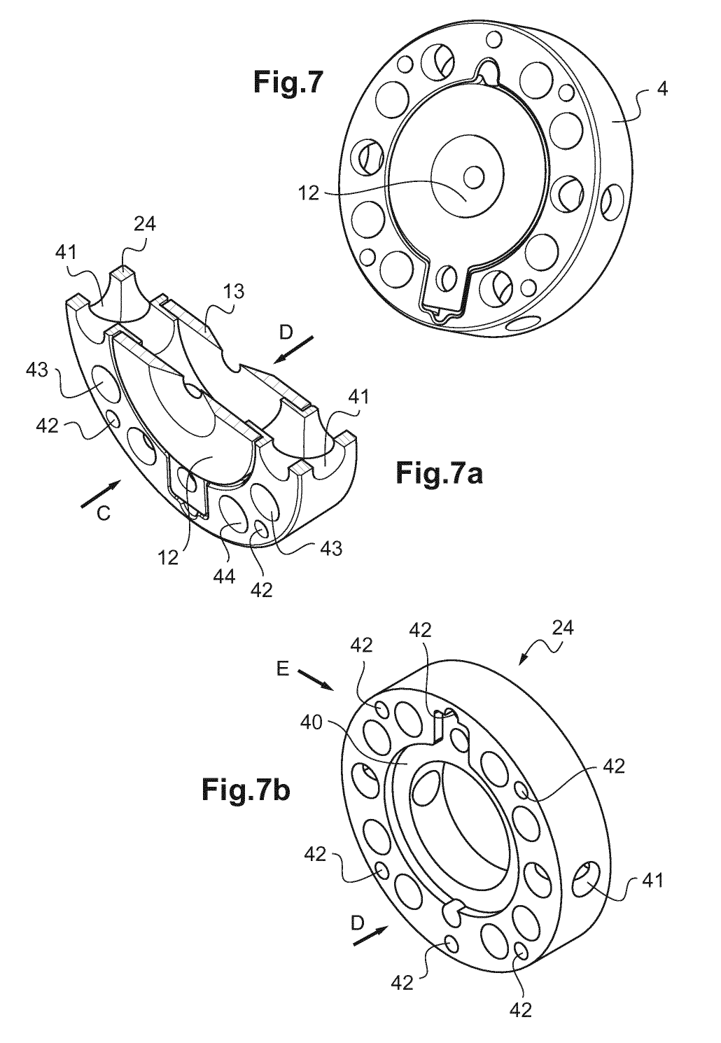

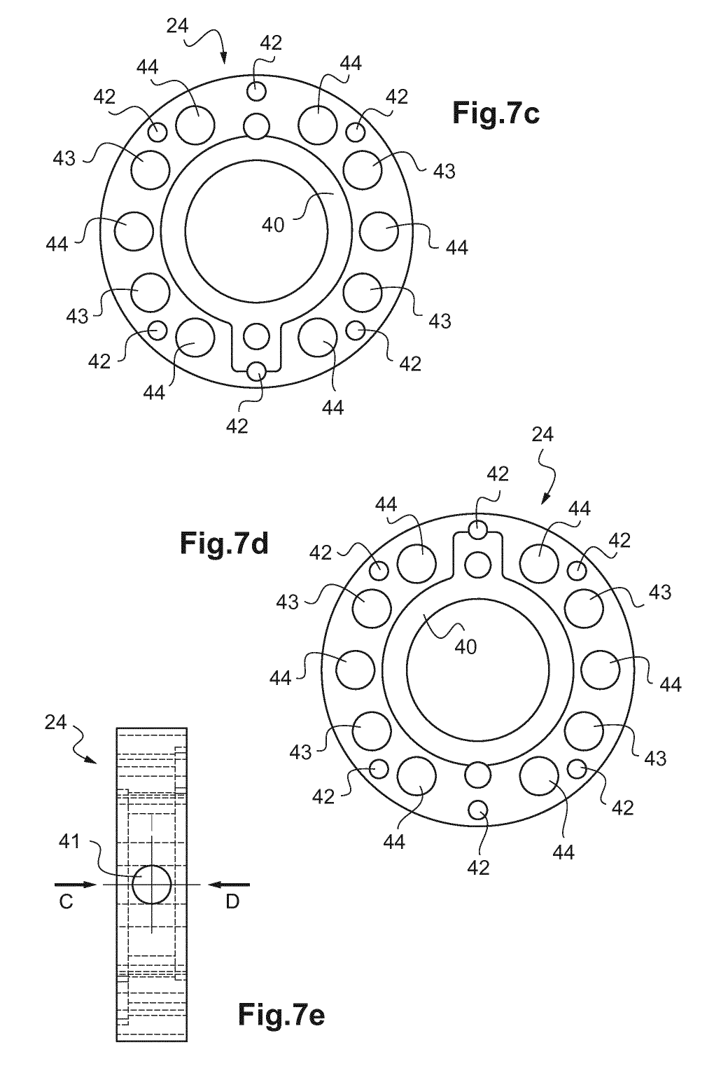

The device 1 also comprises means for applying an electrical field in order to extract said nuclei and direct the duly extracted nuclei toward electrons. In the example described, these means are an electrode 12, which is an anode in the example described, associated with a ground 13 placed on the other side of an insulating electrode holder 24, as illustrated in more detail in FIGS. 7 and 7a to 7e.

As can be seen in these figures, the electrode 12 and the ground 13 are identical, to within their polarity, and the electrode holder 24 takes the form of a ring, comprising two housings 40 for the electrode 12 and the ground 13, which are of identical form.

Furthermore, the electrode holder 24 is pierced with radial orifices 41, two of them in the example described, and which are diametrically opposite. These radial orifices 41 can be used for fixing the electrode holder in the device.

The electrode holder 24 also comprises transverse orifices 42, 43 and 44. The orifices 42 can be used for the passage of electrical connections 7, on the sides of the enclosure 2, being furthest away from the central axis of the enclosure. These orifices 42 are also of smaller diameter. In the example described, there are six of them, being placed symmetrically around the central axis of the enclosure.

The transverse orifices 43 can be used for the passage of spacers 30, which allow for the maintaining of the electrodes and for the support of the target. These spacers can be used for the circulation of one or more heat transfer fluid(s) and the extraction of the heat produced in the device. There are four of them in this example, like the spacers 30, and they are placed symmetrically around the central axis of the enclosure.

Finally, the other transverse orifices 44 can be kept free, being thus able to be used to balance pressures in the device and for the circulation of the gases. There are six of them in the example described being placed symmetrically around the central axis of the enclosure.

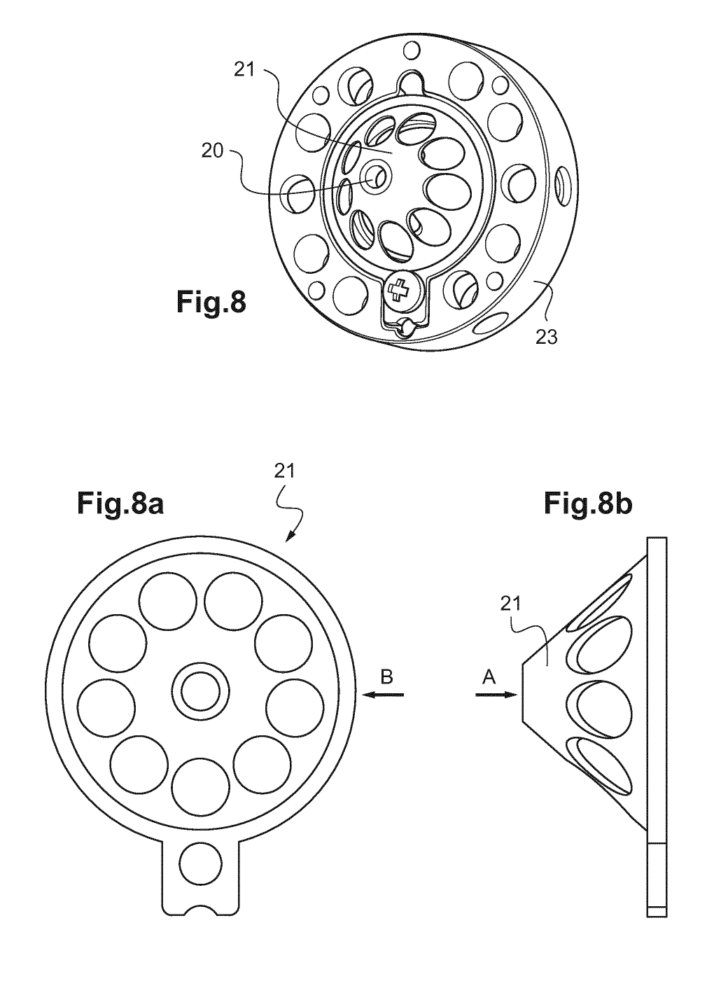

The abovementioned electrons are, in the example described, derived from a beam of electrons extracted from a target 20 held by an insulating electrode holder 23, behind an extraction electrode 25 and a focusing electrode 21. The focusing electrode 21 has a generally tapered form, as illustrated in FIGS. 8a and 8b. The extraction electrode 25 is held on an electrode holder 26, identical to the electrode holder 24 previously described in detail, and the target and the focusing electrode 21 are held on the electrode holder 23, also identical to the electrode holders 24 and 26. The radial orifices 41 can generally be used to fix the target 20 in the electrode holder 23 as illustrated in FIGS. 8, 9 and 10.

The focusing electrode 21 can be, in the example described, a cathode, brought for example to a potential of −300 V, the extraction electrode 25 then being a ground. In a variant, it could of course be otherwise, the focusing electrode 21 being brought to the ground and the extraction electrode 25 being an anode, for example brought to a potential of approximately +300 V. The extraction electrode 25 can thus be brought to different potentials depending on the mode of use: ground, or positive. The focusing electrode 21, illustrated in more detail in FIG. 8, is a cathode or a ground.

The electrons from the target 20 are extracted from the target by the action of the extraction electrode 25 which is linked to the ground or brought to a positive potential, and focused toward the nuclei by means of the focusing electrode 21, which is a cathode in this example, or a ground.

The device could comprise only one electrode out of the extraction electrode and the focusing electrode, without departing from the scope of the present invention.

Each of the electrodes can be produced in the form of a metal grating, and is borne by a corresponding electrode holder with an outline of ceramic or plastic material, allowing the insulation of the connections from one another.

The collision takes place in the intermediate space 28 between the electrodes 13 and 25 both linked to the ground, in the case where the electrons are emitted in beam form.

The device comprises, after the electromagnet with core 10 and electrodes 12 and 13, means for applying a second magnetic field to said electrons so as to give a predefined orientation to the magnetic moments of the electrons. This is in the example described a coreless electromagnet 14. At the core of this electromagnet 14 there are the electrode 13 (ground), the electrode 25 (ground), the electrode 21 (cathode) and the target 20 on its support 23, as illustrated. Thus, the electrons are subjected to the second magnetic field before their collision with the nuclei from the plasma.

At the output, a beam of neutrons is then obtained, that can be harvested at the end 2c of the enclosure 2.

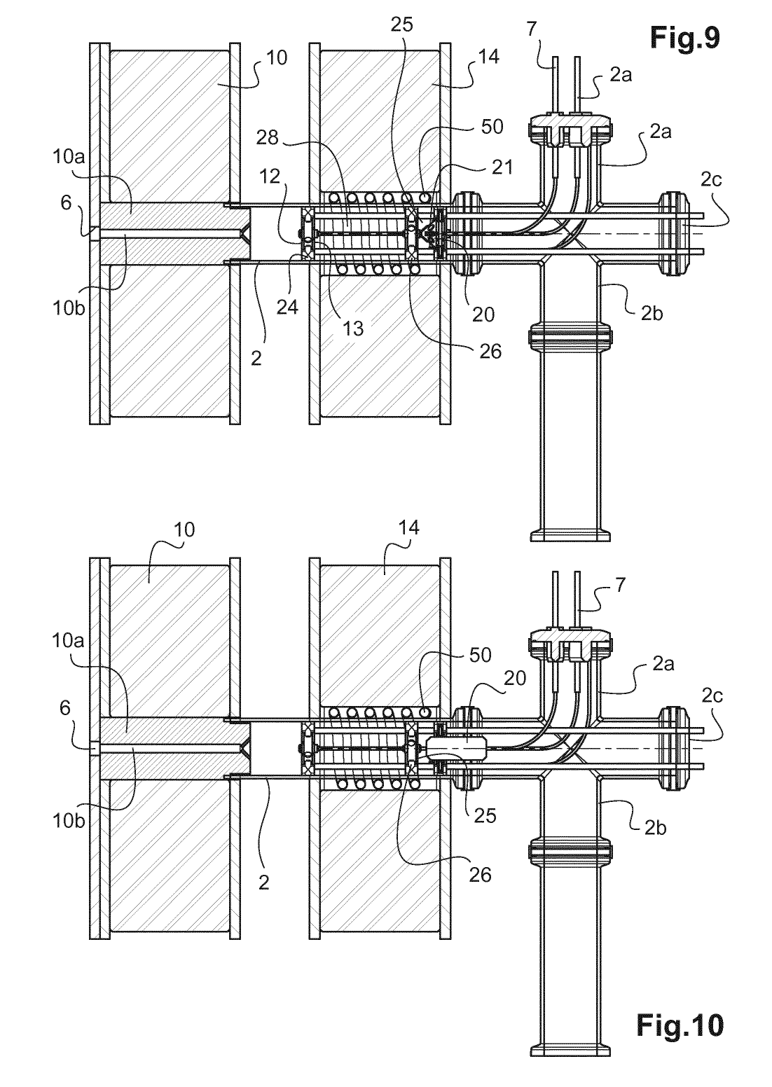

In the variant embodiment illustrated in FIG. 9, the device can comprise a specific radiofrequency antenna 50 for modulating the second magnetic field, such that the electrons are subjected to a combination of the second magnetic field of the electromagnet 14 and of the radiofrequency emitted by the antenna 50. This antenna 50 is placed inside the magnet 14, around the enclosure 2.

In the examples which have just been described, the production of a beam of neutrons is obtained by the capture of the electrons having been extracted from the target 20 by the nuclei of the beam.

The electrons can, as a variant, be contained in the target, which in this case is intended to receive the nuclei. In this case, the electron/nuclei collision can take place directly on or in the target 20 to generate neutrons by virtue of the alignment of the magnetic moments thereof, and it is possible to obtain a transmutation of the atoms (nuclei) of the target by the capture of the neutrons produced. In this exemplary embodiment of neutron production and capture directly in the target, the electrodes and/or ground 12, 13 and 25 can be used as radiofrequency antennas, in order to improve the rate of alignment of the magnetic moments of the nuclei and/or of the electrons of the target, and thus increase the number of neutrons produced. To this end, they can in the variant illustrated in FIG. 10 be connected to a suitable radiofrequency generator.

As an example, FIG. 10 illustrates a device which differs from those previously described by the presence of a target 20 without electrode 21, and which is connected to the ground. Furthermore, the electrode 25 is used only for radiofrequency production and is not subjected to a fixed voltage. In a variant embodiment not illustrated, this electrode 25 could even be eliminated.

The target 20 can have an elongate form, particularly in the direction of the output 2c, so as to facilitate the transmutation of the greatest possible number of atoms. The target 20 can be solid, or fluid, being liquid or including a powder.

The expression “comprising a” should be understood to mean “comprising at least one”.

1. A method for producing and/or capturing neutrons, comprising the following steps:
a) subjecting nuclei chosen from among protons, deuterons and/or tritons to an electrical field in order to extract said nuclei and direct the duly extracted nuclei toward a target (20) containing free electrons,
b) subjecting said nuclei to a spatial and/or temporal gradient of a first magnetic field so as to give a predefined orientation to the magnetic moments of the nuclei, and
c) subjecting the target to a second magnetic field so as to give a predefined orientation to the magnetic moments of the free electrons of the target.

2. The method as claimed in claim 1, in which the magnetic moments of the nuclei and the magnetic moments of the free electrons are aligned in the same direction or are parallel to the direction of displacement of the nuclei toward the target, being in the same direction or in the opposite direction.

3. (canceled)

4. The method as claimed in claim 1, in which the nuclei are obtained by creating a plasma of hydrogen and/or of deuterium and/or of tritium by application of radiofrequencies or of an electrical discharge.

5. The method as claimed in claim 1, in which said nuclei are subjected to radiofrequencies so as to give a predefined orientation to the magnetic moments of the nuclei.

6. The method as claimed in claim 1, in which the target contains ferromagnetic and/or superparamagnetic materials and the target is subjected to a magnetic field so as to give a predefined orientation to the magnetic moments of the free electrons of the target.

7. The method as claimed in claim 1, in which the target is subjected to radiofrequencies so as to give a predefined orientation to the magnetic moments of the free electrons of the target.

8. The method as claimed in claim 4, in which the radiofrequencies are applied using a radiofrequency generator (8), at a frequency lying between 10 kHz and 50 GHz.

9. The method as claimed in claim 1, in which the electrical field applied is obtained by one or more electrode(s).

10. The method as claimed in claim 1, in which the first magnetic field applied has a spatial gradient lying between 0.001 Tesla/meter and 1000 Tesla/meter over the volume of an enclosure (2) containing said nuclei.

11. The method as claimed in claim 1, in which the free electrons of the target are subjected to a spatial and/or temporal gradient of the second magnetic field, and/or in which the target (20) is metal, and/or in which the target (20) is heated to a temperature which lies between 100° C. and 4000° C.

12. (canceled)

13. (canceled)

14. A device for producing and/or capturing neutrons, comprising:
a) an enclosure (2) in which the nuclei chosen from among protons, deuterons and/or tritons can be placed,
b) means for applying a spatial and/or temporal gradient of a first magnetic field so as to give a predefined orientation to the magnetic moments of the nuclei present in the enclosure,
c) means for applying an electrical field in order to extract said nuclei and direct the duly extracted nuclei toward electrons, and
d) means for applying a second magnetic field to said electrons so as to give a predefined orientation to the magnetic moments of the electrons.

15. The device as claimed in claim 14, in which the magnetic moments of the nuclei and the magnetic moments of the free electrons are aligned in the same direction or are parallel to the direction of displacement of the nuclei in the enclosure, being in the same direction or in the opposite direction.

16. (canceled)

17. The device as claimed in claim 14, comprising a radiofrequency generator surrounding the enclosure, making it possible to create a plasma of hydrogen or of deuterium and/or tritium in the enclosure.

18. The device as claimed in claim 14 the means for applying the gradient of the first magnetic field comprising a first electromagnet (10) to produce the first magnetic field.

19. (canceled)

20. The device as claimed in claim 14, the means for applying the electrical field comprising one or more electrode(s) and one or more ground(s), each electrode or pair of electrodes being borne by an electrode holder (24, 23, 26).

21. The device as claimed in claim 20, in which the electrode holder (24, 23, 26) is in the form of a ring, comprising two housings for the electrode and the ground, which can be of identical form.

22. The device as claimed in claim 20, in which the electrode holder (24, 23, 26) comprises transverse orifices, for at least one out of passage for electrical connections, passage for spacers, and/or to balance pressures in the device and for the circulation of the gases.

23. The device as claimed in claim 14, the means for applying the second magnetic field to said electrons comprising a second electromagnet (14) to produce the second magnetic field.

24. The device as claimed in claim 14, comprising a source of electrons making it possible to produce an electron beam.

25. The device as claimed in claim 14, comprising a target (20) containing electrons, intended to receive the nuclei, and/or the target containing ferromagnetic and/or superparamagnetic materials.

26. The device as claimed in claim 14, comprising cooling means and/or energy harvesting means for the production of energy.
